(19) United States
(12) Patent Application Publication
(10) Pub. No.: US 2006/0219829 A1
(43) Pub. Date: Oct. 5, 2006

(54) Removable electronic storage crushing device

(75) Inventor: Charles J. Smith III, Greenville, SC (US)

Correspondence Address: NELSON MULLINS RILEY & SCARBOROUGH, LLP, 1320 MAIN STREET, 17TH FLOOR, COLUMBIA, SC, 29201, US

(73) Assignee: EDR Solutions, LLC

(21) Appl. No.: 11/390,943

(22) Filed: Mar. 28, 2006

Related U.S. Application Data
(60) Provisional application No. 60/666,403, filed on Mar. 30, 2005.

(51) Int. Cl. A47J 17/00

(52) U.S. Cl. 241/168; 241/198.1

(57) ABSTRACT

A removable electronic storage crushing device having a housing, a cylinder, a rod, a crushing head, and a receiving plate. The cylinder is threadedly received in the house and the rod an end of the rod is threadedly received by the crushing head. A source of power is operatively connected to the cylinder, which is operatively connected to the rod. Applying power or force to the cylinder biases the rod and the crushing head in a direction generally parallel to the housing's central axis toward a receiving plate, which defines a bore configured to receive at least part of the crushing head. When the crushing head comes into contact with a removable electronic storage device situated on top of the receiving plate, the force applied by the crushing head crushes the removable electronic storage device and any platters therein.

### CLAIM OF PRIORITY

This application claims priority to U.S. Provisional Application No. 60/666,403, filed on Mar. 29, 2005, the entire disclosure of which is incorporated by reference herein.

### FIELD OF THE INVENTION

This invention relates to devices used to destroy or render unreadable electronic storage devices and/or other electronic components storing information.

### BACKGROUND OF THE INVENTION

Information stored on hard drives or other removable electronic storage devices of a computer often contain confidential or private information. Companies have employed software and other digital means in an attempt to destroy or remove this information when the hard drive, removable electronic storage device, or entire computer is no longer needed. These methods have proven ineffective as they often leave traces or remnants of the data which contain the data itself or can be used to reconstruct the data. Other methods have been used in an attempt to physically destroy the hard drives, but these methods also fail to render the hard drive completely inoperable, allowing data to be reconstructed.

### SUMMARY OF THE INVENTION

The present invention recognizes and addresses the foregoing considerations, and others, of prior art construction and methods. Accordingly, it is an object of the present invention to provide an improved removable electronic storage crushing device. This and other objects are achieved by a device comprising a housing having a central axis, a crushing head moveably positioned within the housing that has a width generally equal to its length. The device includes an elongated rod operatively coupled to the crushing head, which biases the crushing head in a first direction generally parallel to the housing's central axis. A receiving plate is configured to receive a removable electronic storage device and defines a bore configured to receive at least a portion of the crushing head.

The device may also include a cylinder operatively coupled to the elongated rod that biases the crushing head in the first direction generally parallel to the housing's central axis. Examples of the cylinder include a hydraulic cylinder or a pneumatic cylinder operatively connected to a hand pump. The cylinders may also be coupled to an electric pump that supplies fluid or air pressure to the cylinder. In other embodiments, the housing may include a plurality of gears connected to the elongated rod and to a hand crank so that when the hand crank is rotated, the crushing head is biased in the first direction. Alternatively, an electric motor may be coupled to the plurality of gears and drive the rod downward along the housing central axis.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is a perspective view of a removable electronic storage crushing device in accordance with an embodiment of the present invention;

FIG. 2 is a perspective view of a crushing head for use in the removable electronic storage crushing device of FIG. 1;

FIG. 3a is an exploded perspective view of the removable electronic storage crushing device of FIG. 1;

FIG. 3b is a perspective view of a receiving plate for use in the removable electronic storage crushing device of FIG. 1;

FIG. 3c is a perspective view of a receiving bin for use in the removable electronic storage crushing device of FIG. 1;

FIG. 4 is a perspective view of the removable electronic storage crushing device of FIG. 1 with a hard drive being inserted;

FIG. 5 is a perspective view of a removable electronic storage crushing device in accordance with an embodiment of the present invention;

FIG. 6 is a perspective view of a removable electronic storage crushing device in accordance with an embodiment of the present invention; and

FIG. 7 is a perspective view of a removable electronic storage crushing device in accordance with an embodiment of the present invention.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

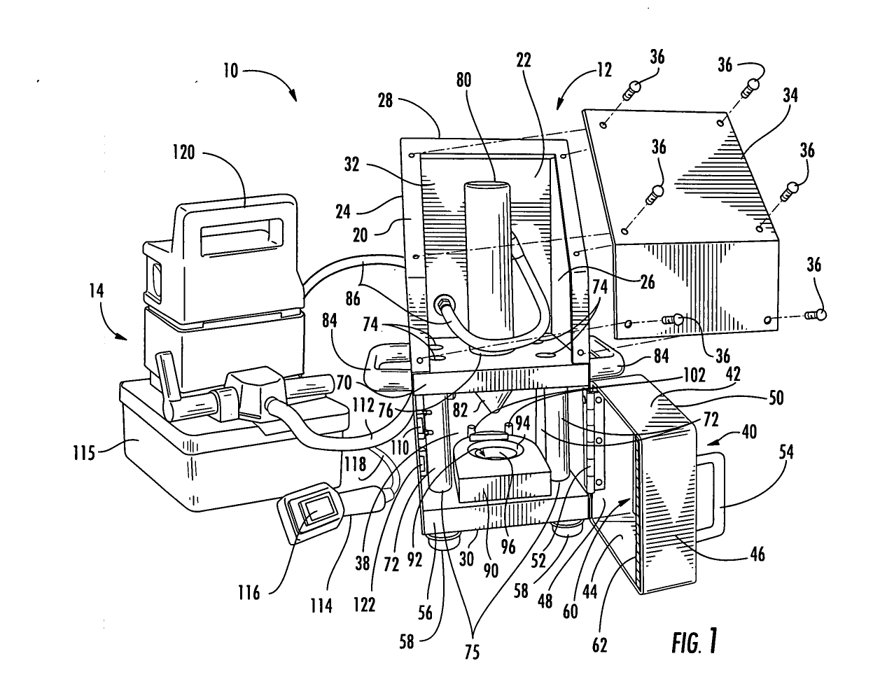

Referring to FIG. 1, a removable electronic storage crushing device 10 is shown having a chamber 12 and an electric pump 14. Chamber 12 is generally rectangular having a front wall 20, a back wall 22, two side walls 24 and 26, a top wall 28, a bottom wall 30, and a door 40. Chamber 12 is generally divided into an upper portion 32 and a lower portion 38. Front wall 20 adjacent to upper portion 32 is generally planar with a slope. A cover 34 removably attaches to front wall 20 by screws (collectively denoted at 36). It should be understood that cover 34 may be attached by any suitable fastener such as bolts, rivets, etc.

Door 40 covers lower portion 38 and is generally rectangular in shape having a top wall 42, a bottom wall 44, two side walls 46 and 48, and a front wall 50. Door front wall 50 is composed of a clear material, such as Plexiglas, to allow the user to see into lower portion 38 during operation of device 10. It should be understood that, while door front wall 50 is composed of clear material in one embodiment, any material suitable to allow the user to view inside lower portion 38 during operation of device 10 may be used, such as glass, mineral, etc. Moreover, in the alternative, door front wall 50 may be opaque.

Still referring to FIG. 1, the side opposite door front wall 50 (denoted by arrow 60) is generally open except for a small rectangular metal piece 62 attached to door top wall 42, bottom wall 44, and side wall 46. A plurality of hinges (collectively denoted at 52) connect lower portion side wall 26 to door side wall 48, such that door 40 is able to open 180 degrees with respect to chamber 12. It should be understood that other methods of attaching door section 40 to lower portion 38 may be employed. A handle 54, attached to door front wall 50, allows the operator to easily open the door to insert or remove an item to be crushed. Chamber bottom wall 30 is comprised of a base plate 56 that includes a plurality of rubber feet (collectively denoted at 58) to provide a non-slip connection between chamber 12 and the surface that it sits on.

A middle plate 70 separates chamber upper portion 32 from chamber lower portion 38. A plurality of support columns (collectively denoted at 72) are affixed between middle plate 70 through a plurality of holes (collectively denoted at 74) and base plate 56 through a plurality of holes (collectively denoted at 75). Middle plate 70 defines a large threaded through-hole 76 generally located in the center of the middle plate. Two handles 84 are secured on the outside of respective sidewalls 24 and 26 to middle plate 70 by bolts (not shown). It should be understood that any suitable means of attaching the handles to middle plate 70 is contemplated.

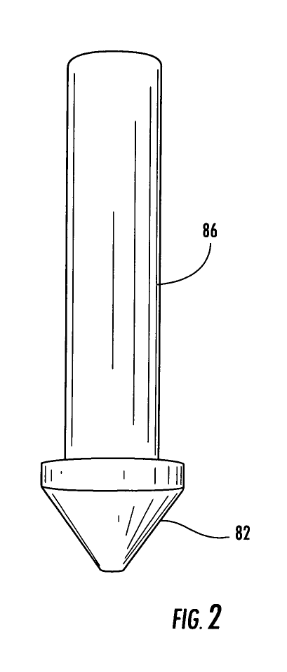

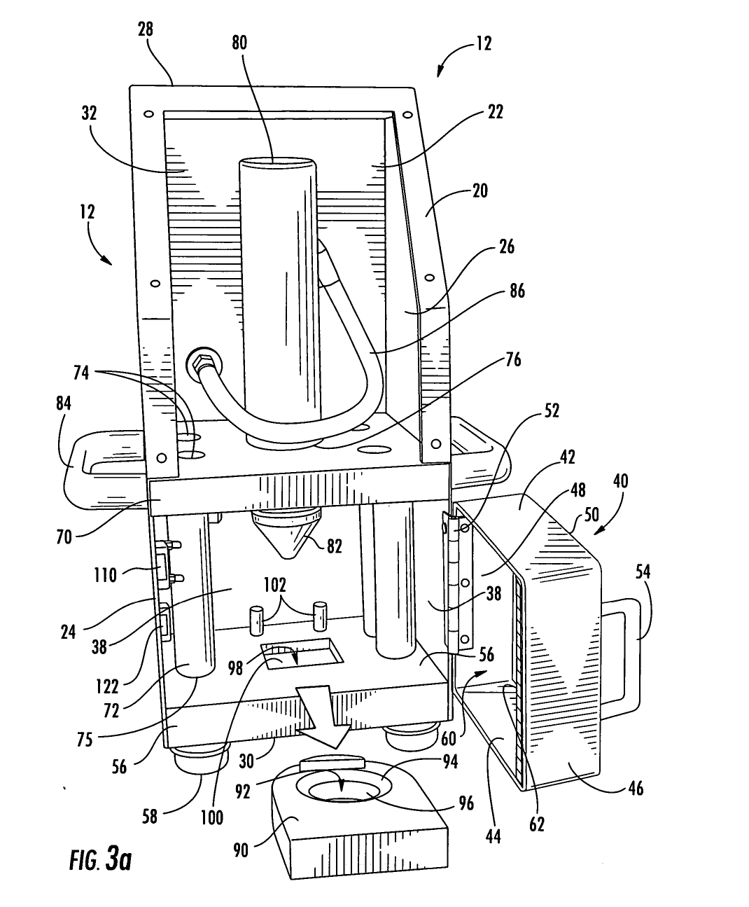

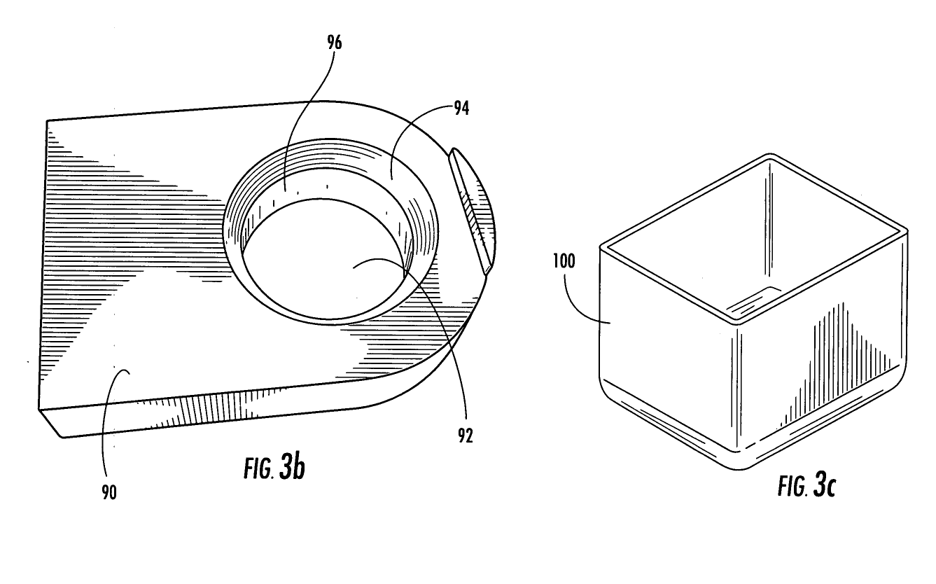

A hydraulic power cylinder 80 is threadedly received in hole 76 such that a rod 86 (FIG. 2) of cylinder 80 may be biased into chamber lower portion 38 when hydraulic power cylinder 80 is actuated. Hydraulic power cylinder 80 is operatively connected to electric pump 14 via a hose 86 (FIGS. 1 and 3a). Hydraulic power cylinders should be understood in this art and are therefore not discussed in further detail. One example of a hydraulic power cylinder is the RC-106 available from Enerpac Corporation in Milwaukee, Wis. Referring to FIG. 2, cylinder rod 86 is threadedly received in a frustoconical shaped crushing head 82. It should be understood to one of skill in the art that crushing head 82 may employ different shapes, such as pyramidal, triangle, conical, wedge, etc.

Referring to FIGS. 3a and 3b, a removable receiving plate 90, situated in chamber lower portion 38, defines an area on which a removable electronic storage device, such as a hard drive for a computer, may be placed. Receiving plate 90 defines a through-hole 92 having a generally conical first portion 94 and a generally circular second portion 96. It should be understood that receiving plate 90 may be joined to, or integrally formed with, base plate 56. Base plate 56 defines a hole 98 (FIG. 3a) that receives a removable receiving bin 100 (FIGS. 3a and 3c). Receiving bin 100 fits within base plate hole 98 and extends below bottom wall 44 onto a support surface on which chamber 12 sits. A stop formed from a plurality of vertical posts 102 abuts receiving plate 90 when the plate is positioned correctly within chamber lower portion 38, such that holes 92 and 98 and crushing head 82 are generally aligned along the central axis of chamber 12. In other embodiments, stop 102 may be formed from any suitable material and shape that allows for the alignment of the receiving plate 90, holes 92 and 98, and crushing head 82.

Still referring to FIG. 3a, an electronic safety switch 110, affixed to the inside of sidewall 24, is positioned to contact door metal piece 62 when the door is closed. Safety switch 110 connects to electric pump 14 via electric cord 112. A magnet 122, located below safety switch 110, also comes into contact with door metal piece 62 when the door is closed to retain the door in the closed position.

Referring again to FIG. 1, an operating handle 114, on which a button 116 is located, connects to electric pump 14 via a second electric cord 118 and is used to actuate the electric pump. It should be understood to one skilled in the art that button 116 can be relocated anywhere on device 10, such as upper portion side wall 26 (see FIG. 7). A fluid storage tank 115 is located at the bottom of electric pump 114 and supplies fluid to hydraulic power cylinder 80 via hose 86. A carrying handle 120, located on the top portion of electric pump 14, allows the operator to lift and carry the pump from location to location. Electric pumps should be understood in this art and are therefore not discussed in further detail. An example of such an electric pump is the PUD-1101B available from Enerpac Corporation in Milwaukee, Wis. A user may lift and carry device 10 to a desired location using handles 84 and 120. Once set down, rubber feet 50 support chamber 12, supply enough friction so that chamber 12 does not move while in operation, and protects the support surface on which chamber 12 is placed from damage.

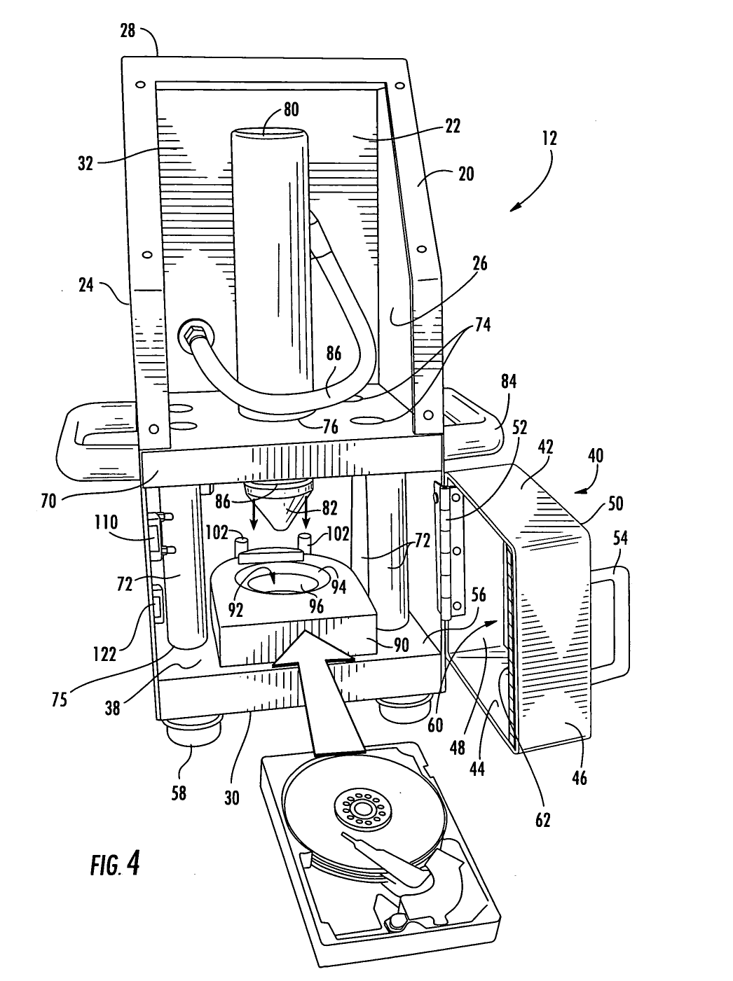

In operation, and referring to FIG. 4, door 40 is opened using handle 54, and receiving plate 90 is removed from chamber lower portion 38. A removable electronic storage device, such as a computer's hard drive, is placed in a generally lengthwise manner on receiving plate 90, which is then returned to chamber lower portion 38. Receiving plate 90 is guided into place by support columns 72 and stop 102. An oversized removable electronic storage device may extend beyond the area defined by chamber lower portion 38 into the open area 60 defined by door section 40 if needed. A smaller removable electronic storage device, such as a hard drive for use in a laptop computer, may be placed widthwise on receiving plate 90. It should be understood that in an embodiment where receiving plate 90 is non-removable or is integral with base plate 56, the removable electronic storage device is inserted directly onto receiving plate 90.

Using handle 54, the user closes door 40, and magnet 122 retains the door in the closed position. In this position, rectangular piece 62 comes in contact with safety switch 110, causing the electric path created by safety switch 110, cord 112, and electric pump 14 (FIG. 1) to be closed thereby allowing the pump to be actuated.

Once door 40 is closed, the user depresses button 116 (FIG. 1) to activate electric pump 14 forcing fluid from storage tank 115 through hose 86 into hydraulic power cylinder 80. The hydraulic pressure created by electric pump 14 in hydraulic power cylinder 80 causes cylinder rod 86 to extend generally along the central axis of chamber 12 causing crushing head 82 to come into contact with the removable electronic storage device situated on receiving plate 90. Continued depression of button 116 causes crushing head 82 to push through the removable electronic storage device and into receiving plate through-hole 92. The removable electronic storage device and any memory platters contained therein are crushed and deformed between crushing head 82 and receiving plate 90. That is, as crushing head 82 applies downward force on the storage device, the storage platters within the storage device deform, causing the platters to shatter into multiple pieces.

Previously, the mere piercing of a removable electronic storage device has been used as an attempt to prohibit data from being retrieved from the storage device. When the removable electronic storage device is a hard drive for a computer, or any other similar storage device that uses platters to store information, piercing the platters leaves a possibility that they may remain operable and/or that data can be reconstructed from the platters. The action of crushing head 82 on the storage device causes the platters to shatter prohibiting their operation and rendering the hard drive and platters unusable.

Once the crushing action is completed, button 116 is released allowing cylinder rod 86 to retract into cylinder 80 as the hydraulic fluid empties from cylinder 80 back into a fluid storage tank 115. Once the rod is fully retracted, the user opens door 40 and removes the crushed removable electronic storage device. The majority of any debris from the crushed storage device that breaks lose during the crushing process should fall through hole 98 (FIG. 3a) into receiving bin 100 (FIGS. 3a and 3c), which can then be removed and cleaned. Although receiving bin 100 is shown as being in contact with base plate 56, it should be understood that the function of receiving bin 100 can be accomplished by other devices, such as a shallower receiving plate (not shown) that sits below base plate hole 98 and is capable of collecting debris falling through hole 98. In other embodiments, receiving bin 100 may be eliminated altogether allowing debris to fall through base plate hole 98 onto and/or through the surface supporting chamber 12. This configuration allows for the scenario wherein chamber 12 is placed over a larger receptacle for receiving debris, such as at an industrial waste bin.

It should be understood by one skilled in the art that other means of biasing rod 138 and crushing head 82 may be employed, such as an electric motor, pneumatic pump, etc., as long as those means are able to supply a sufficient force to crush a hard drive. Forces in the range of approximately 1500 to 2,300 pounds per square inch are sufficient to crush the hard drive and shatter the platters. The force, when applied to the platters of a removable electronic storage device, such as a computer's hard drive, will generally render the platters unusable.

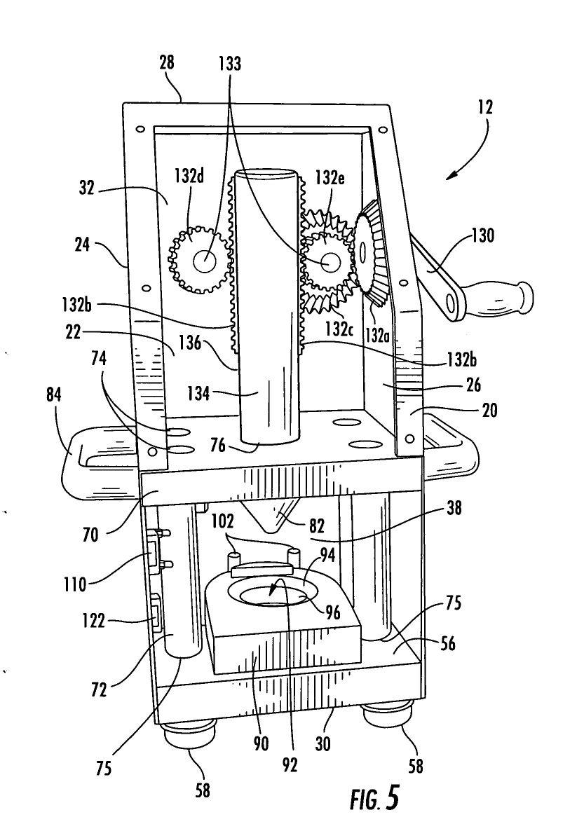

Referring to FIG. 5, in another embodiment of crushing device 10, the components employed to bias cylinder rod 86, including electric pump 14, power cylinder 80, and their corresponding parts as shown in FIG. 1, are replaced by a hand crank 130, a plurality of gears (collectively denoted by 132), and a manual cylinder 134. Hand crank 130 is affixed on the outside of chamber side wall 26 to a gear 132a by a suitable fastener such that gear 132a is rotationally fixed to handle 130. Manual cylinder 134 has an outer support shell 136 and a moveable internal rod (not shown), which replaces cylinder rod 86. Threaded through-hole 76 threadedly receives hand cylinder outer shell 136 in a manner identical to that of power cylinder 80, as described above with reference to FIG. 1.

The moveable internal rod (not shown) has two linear sets of teeth 132b formed on opposite sides and that extend through slots (not shown) formed through support shell 136. Teeth 132b are interengaged with, and retain moveable internal rod (not shown) between two gears 132d and 132e. That is, gears 132d and 132e interengage with rod teeth 132b and prevent the rod from pivoting side to side. Crushing head 82 threadedly receives the internal rod (not shown).

Hand crank 130 is operatively connected to the moveable internal rod (not shown) by gears 132a, 132c, 132d, and 132e. Gears 132c, 132d and 132e are rotatably coupled to chamber upper portion back wall 22 by two spindles 133, and gears 132c and 132e are rotationally fixed to one another and rotate in unison about spindle 133. Thus, rotating hand crank 130 clockwise (looking at FIG. 5 from the right) rotates gear 132a clockwise, which in turn drives gears 132c and 132e clockwise about spindle 133. The clockwise rotation of gears 132c and 132e biases the moveable internal rod (not shown) upward in a linear motion on an axis generally central to chamber 12, which also causes gear 132d to rotate counterclockwise. Likewise, rotating hand crank 130 counterclockwise biases the moveable internal rod (not shown) downward so that crushing head 82 comes into contact with an electronic storage device loaded on receiving plate 90. The other parts of chamber 12 generally function in the same manner as described above with respect to FIG. 1 and thus an explanation of their operation will not be repeated. The use of varying sizes and shapes of gears to produce the required amount of crushing force should be understood in the art. Moreover, it should be evident that placement and length of hand crank 130 can be altered to more suitable positions to increase or decrease the desired force.

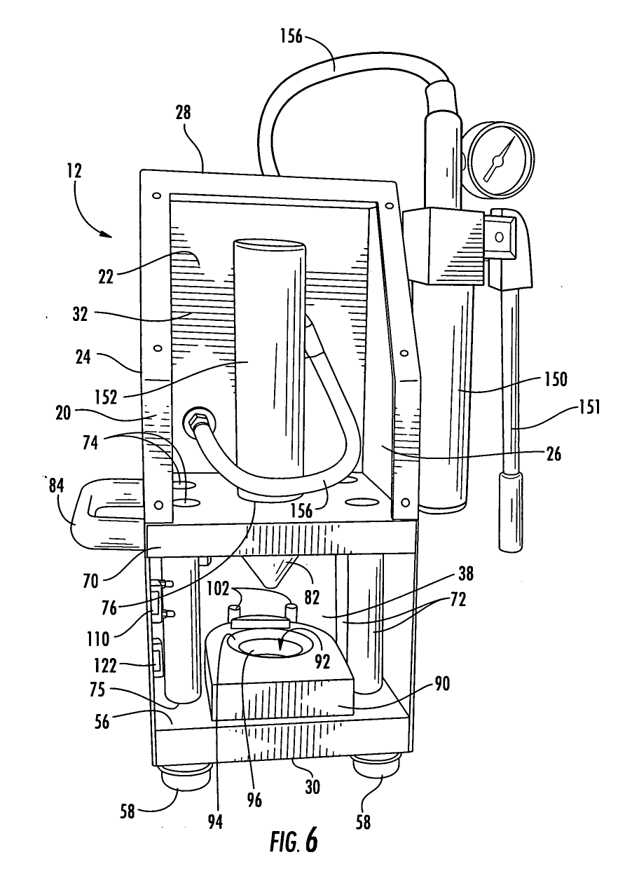

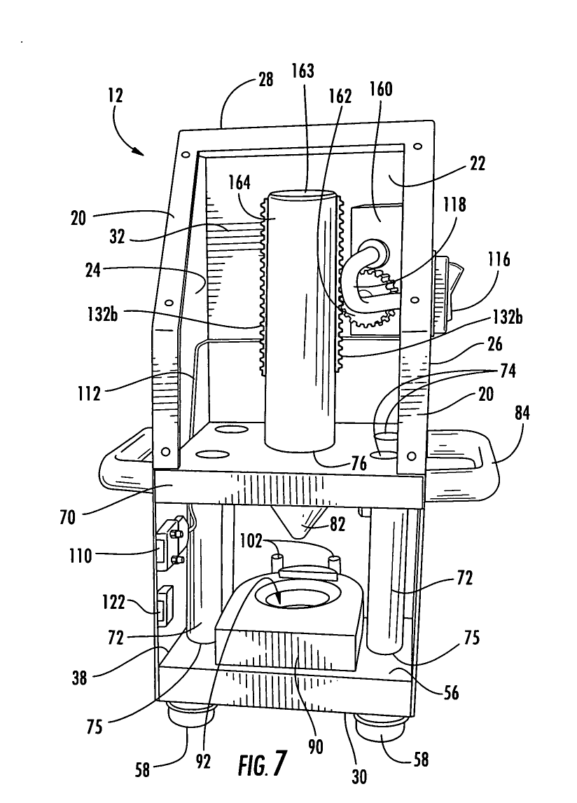

An example of another method of biasing moveable internal rod (not shown) and crushing head 82 is a pneumatic hand pump. Referring to FIG. 6, a hand pump 150 if affixed to chamber wall 26 in a manner similar to that of hand crank 130 as described above with reference to FIG. 5. A pneumatic cylinder 152, which includes a moveable internal rod (not shown) generally identical to rod 86 (FIG. 2), is threadedly received by threaded through-hole 76 in a manner identical to the embodiments described above. Likewise, crushing head 82 threadedly receives the internal rod (not shown). Cylinder 152 is attached to pneumatic hand pump 150 by a hose 156. Pneumatic hand pumps should be understood in this art and are therefore not discussed in further detail. An example of such a hand pump is the P-392 PUMP-CYLINDER SET available from Enerpac Corporation in Milwaukee, Wis.

In operation, a user pumps hand pump 150 by a handle 151, which supplies air pressure through pump hose 156 to pneumatic cylinder 152. The air pressure in cylinder 152 biases the internal rod (not shown) downward from cylinder 152 moving crushing head 82 into contact with a removable electronic storage device. As the user continues to pump hand pump 150, the pneumatic force is sufficient to cause crushing head 82 to crush the removable electronic storage device placed on receiving plate 90 in a manner similar to that described above.

In yet another embodiment as shown in FIG. 7, button 116 is relocated from operating handle 114 (FIG. 1) onto chamber side wall 48. Power cord 118 is relocated to inside chamber upper portion 32 and connects button 116 to an electric motor 160. Electric motor 160 includes a large rotating gear 162 operatively connected to a moveable internal rod (not shown) of a cylinder 163. Cylinder 163 has an outer support shell 164 threadedly received into through-hole 76 and operates in a manner generally identical to cylinder 134, support shell 136, and the associated internal rod (not shown) as described above with respect to FIG. 5.

Thus, pressing button 116 activates motor 160. Gear 162 is rotationally driven by motor 160 and biases the internal rod (not shown) in a downward direction generally parallel to the central axis of chamber 12. Likewise, crushing head 82 is biases by the internal rod (not shown) in a manner generally similar to that described above with reference to FIG. 5. Releasing button 116 deactivates motor 160 causing gear 162 to rotate in an opposite direction returning crushing head 82 to its home position. Alternatively, a control switch (not shown) can be included that reverses the direction of motor 160 when a sufficient crushing force has been achieved thereby preventing overdriving of the motor in the downward crushing direction. Additionally, a proximity switch may be included that senses when the crushing head has reached a predetermined downward extension.

While one or more preferred embodiments of the invention have been described above, it should be understood that any and all equivalent realizations of the present invention are included within the scope and spirit thereof. The embodiments depicted are presented by way of example only and are not intended as limitations upon the present invention. Thus, it should be understood by those of ordinary skill in this art that the present invention is not limited to these embodiments since modifications can be made. Therefore, it is contemplated that any and all such embodiments are included in the present invention as may fall within the scope and spirit thereof.

What is claimed is:

1. A removable electronic storage crushing device comprising:
a. a housing having a central axis;
b. a crushing head moveably positioned within said housing;
c. an elongated rod operatively coupled to said crushing head, said elongated rod biasing said crushing head in a first direction generally parallel to said housing central axis; and
d. a receiving plate configured to releasably receive a removable electronic storage device, said receiving plate defining a bore therein configured to receive at least a portion of said crushing head.

2. The removable electronic storage crushing device of claim 1, further comprising a cylinder operatively couple to said elongated rod, wherein said cylinder biases said crushing head in said first direction.

3. The removable electronic storage crushing device of claim 2, wherein said cylinder is a pneumatic cylinder.

4. The removable electronic storage crushing device of claim 2, wherein said cylinder is a hydraulic cylinder.

5. The removable electronic storage crushing device of claim 2, wherein said cylinder is operatively coupled to a hand pump.

6. The removable electronic storage crushing device of claim 1, further comprising a motor operatively coupled to said elongated rod, wherein said motor biases said crushing head in said first direction.

7. The removable electronic storage crushing device of claim 1, further comprising
a. a plurality of gears operatively coupled to said elongated rod; and
b. a hand crank operatively coupled to said plurality of gears, wherein when
said hand crank is rotated in a first direction, said hand crank biases said crushing head in said first direction, and
said hand crank is rotated in a second direction, said hand crank biases said crushing head in a second direction.

8. The removable electronic storage crushing device of claim 1, wherein said crushing head has a width generally equal to its length.

9. A removable electronic storage crushing device comprising:
a. a housing having a central axis;
b. a crushing head moveably positioned within said housing;
c. an elongated rod operatively coupled to said crushing head;
d. a cylinder mounted in said chamber and operatively coupled to said elongated rod, wherein said cylinder biases said crushing head in a first direction generally parallel to said housing central axis; and
e. a base portion configured to receive a removable electronic storage device, said base portion defining a bore therein configured to receive at least a portion of said crushing head.

10. The removable electronic storage crushing device of claim 9, wherein said cylinder is a pneumatic cylinder.

11. The removable electronic storage crushing device of claim 9, wherein said cylinder is a hydraulic cylinder.

12. The removable electronic storage crushing device of claim 10, further comprising a hand actuated air pump that is operatively connected to said pneumatic cylinder.

13. A removable electronic storage crushing device comprising:
a. a housing having a central axis;
b. a crushing head moveably positioned within said housing;
c. an elongated rod operatively coupled to said crushing head, said elongated rod biasing said crushing head in a first direction generally parallel to said housing central axis; and
d. a base portion configured to receive a removable electronic storage device, said base portion defining a bore therein configured to receive at least a portion of said crushing head.

14. The removable electronic storage crushing device of claim 13, further comprising a cylinder operatively couple to said elongated rod, wherein said cylinder biases said crushing head in said first direction.

15. The removable electronic storage crushing device of claim 14, wherein said cylinder is a hydraulic cylinder.

16. The removable electronic storage crushing device of claim 13, further comprising at least one gear operatively coupled to said elongated rod.

17. The removable electronic storage crushing device of claim 16, further comprising a motor operatively coupled to said at least one gear, wherein said motor biases said crushing head in said first direction.

18. The removable electronic storage crushing device of claim 17, wherein said at least one gear is a linear set of gear teeth formed along the length of said elongated rod.

19. The removable electronic storage crushing device of claim 16, further comprising a hand crank operatively coupled to said at least one gear, wherein said hand crank biases said crushing head in said first direction.

20. The removable electronic storage crushing device of claim 13, wherein said crushing head has a width generally equal to its length.
